(19) United States
(12) Patent Application Publication
(10) Pub. No.: US 2003/0110225 A1
(43) Pub. Date: Jun. 12, 2003

(54) Internet-based cooperative e-mail advertising medium

(76) Inventor: Gene A. Billadeau, Chask, MN (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/269,408

(22) Filed: Oct. 11, 2002

Related U.S. Application Data
(60) Provisional application No. 60/329,116, filed on Oct. 12, 2001.

(51) Int. Cl. G06F 15/16

(52) U.S. Cl. 709/206

(57) ABSTRACT

Disclosed is an automated system of producing and distributing an Internet-based, cooperative mass advertising Medium that is delivered via graphically enhanced e-mail to individual recipients (“customers”) who have expressed interest in receiving the information. Each single distribution of the Medium (an “issue”) incorporates messages from multiple, common-interest related “advertisers” who purchase advertising “space” within a given issue. The advertisements are viewed one-at-a-time in a linear manner through use of a common graphical navigation interface, which surrounds the advertisements. The Medium is designed to supply an exposure to a commercial message that also serves as a portal to additional information by incorporation of a “referral hyperlink” to an advertiser-specified URL (home page or product page “deep link”). This feature facilitates immediate information fulfillment via the advertiser's own web site.

### CROSS-REFERENCE TO RELATED APPLICATION

This application claims priority from provisional application No. 60/329,116 filed Oct. 12, 2001, the entire contents of which are hereby incorporated by reference.

### BACKGROUND OF THE INVENTION

This application relates to an internet-based cooperative e-mail advertising medium. More specifically, this application relates to an e-mail distributed bundle of advertising.

With the increasing popularity of the Internet and the World Wide Web, it has become common practice for merchants and manufacturers to create web sites for marketing of their goods and services. Because of the vast, virtually infinite structure of the Internet and the World Wide Web one problem encountered by online merchants and manufacturers is the inability of prospective customers to find exactly the product or service they are seeking. Additionally conventional marketing materials presented on a web site must be actively sought by a potential customer, which can require significant expertise and effort on the part of the customer.

One solution to these problems for an individual merchant is to market their web site through television, newspaper, magazine and Internet advertisements. Another solution to promote a web site would be for the merchant to actively seek to contact potential customers directly. However, advertising a web site using conventional methods or attempting to contact potential prospects directly can be expensive, and can consume significant human resources. In many cases the merchant lacks the resources or expertise needed to efficiently communicate with customers and prospects.

The present invention addresses these and other problems.

### BRIEF SUMMARY OF THE INVENTION

The present invention describes an advertising Medium based upon cooperative mass delivery of interest or occupational-related advertising content to users via e-mail. The present invention also describes a system of automation involved in the production and distribution of said Medium. Utilizing a simple, intuitive interface, the Medium provides a fast, efficient and easy means of browsing offers from multiple merchants and manufacturers, (referred to herein as “advertisers”) and “one-click information facilitated through the use of advertiser-specified hyperlinks that directs the user to a specific location within the advertiser's web site.

The Medium is analogous to a digital incarnation of the familiar printed “action card” or “postcard pack” media, which consists of a series of business reply postcard advertisements distributed via bulk mail to selected groups based on interest or occupation. Unlike traditional action cards however, the Medium is designed to be delivered primarily via e-mail. The Medium seeks to capture the immediacy and simplicity of the action card by incorporating brief, simple advertisements, facilitating low bandwidth delivery of graphics, as well as allowing the user to browse the contents of the Medium quickly

The Medium fulfills a new advertising media niche in that it is a completely unique concept (known) based on a familiar and accepted media. Faster, lower cost distribution via e-mail and the ability to incorporate active hyperlinks and additional media enhancements provide strong benefits to both advertisers and the audience versus printed counterparts. The Medium is easily replicated into multiple markets or multiple uses, and is uniquely able to deliver product news faster into a given market than conventional print-based mass media. It is distinctive from conventional web site-based marketing information that requires the reader to actively seek it—or in the case of web-based advertising such as so-called “banner ads”, delivers content to readers where none is sought.

### BRIEF DESCRIPTION OF THE SEVERAL VIEWS OF THE DRAWING(S)

These and other features and advantages of the invention will now be described with reference to the drawings of certain preferred embodiments, which are intended to illustrate and not to limit the invention.

FIG. 1 is an architectural drawing and flow diagram illustrating the primary components of the web site designed to register recipients to receive the Medium, and mechanisms designed to facilitate purchase of advertising space and transmission of graphic images and data from advertisers in an automated manner

FIG. 2 is an architectural drawing and flow diagram illustrating the function and primary components of the deliverable Medium that operates in accordance with the present invention.

FIG. 3 is a screen display of a typical web site homepage for a Medium that operates in accordance with the present invention.

FIG. 3a-3d are respective screen displays further illustrating the advertiser contracting, file transfer and e-commerce functions.

FIG. 4 is a screen display illustrating an HTML form illustrating the registration (enrollment) function of the system.

FIG. 5 is a screen display illustrating an example of the delivered Medium and the graphical user interface that operates in accordance with the present invention.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

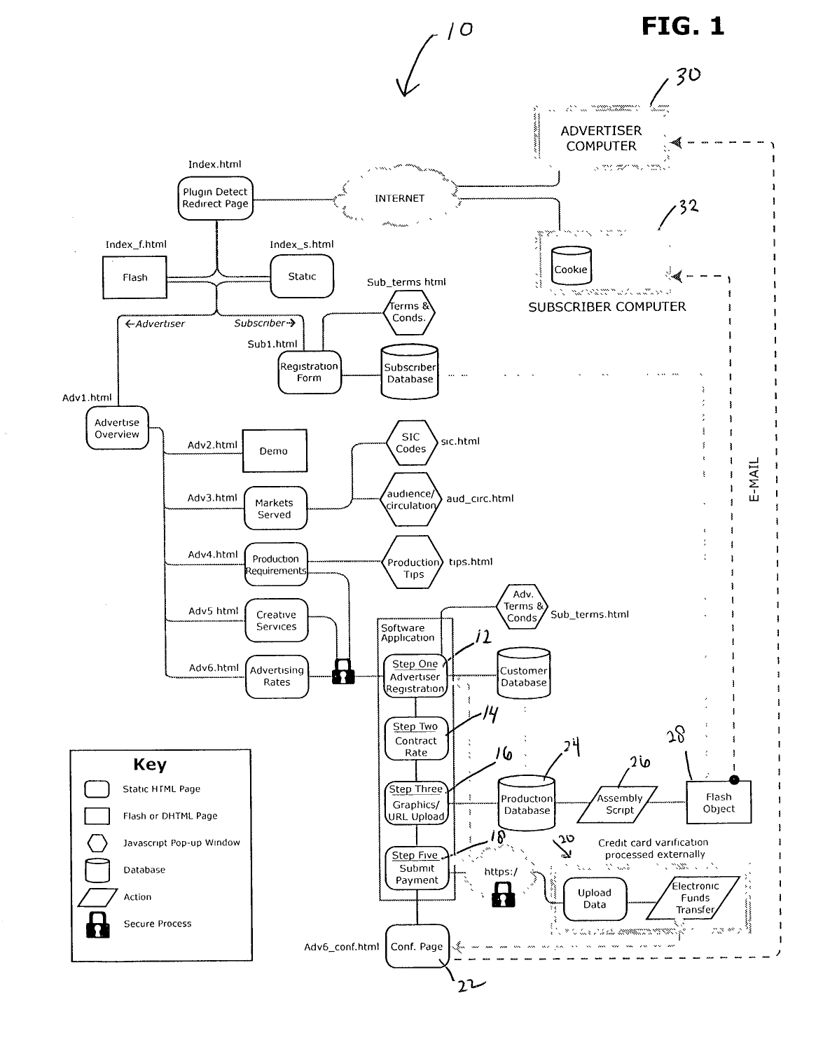

Referring generally to FIG. 1, in accordance with one aspect of the invention, an automated “system” facilitating the production and distribution of the advertising Medium, shown generally at 10, consists of 1) a web site; and 2) the deliverable Medium itself.

1) The Web Site

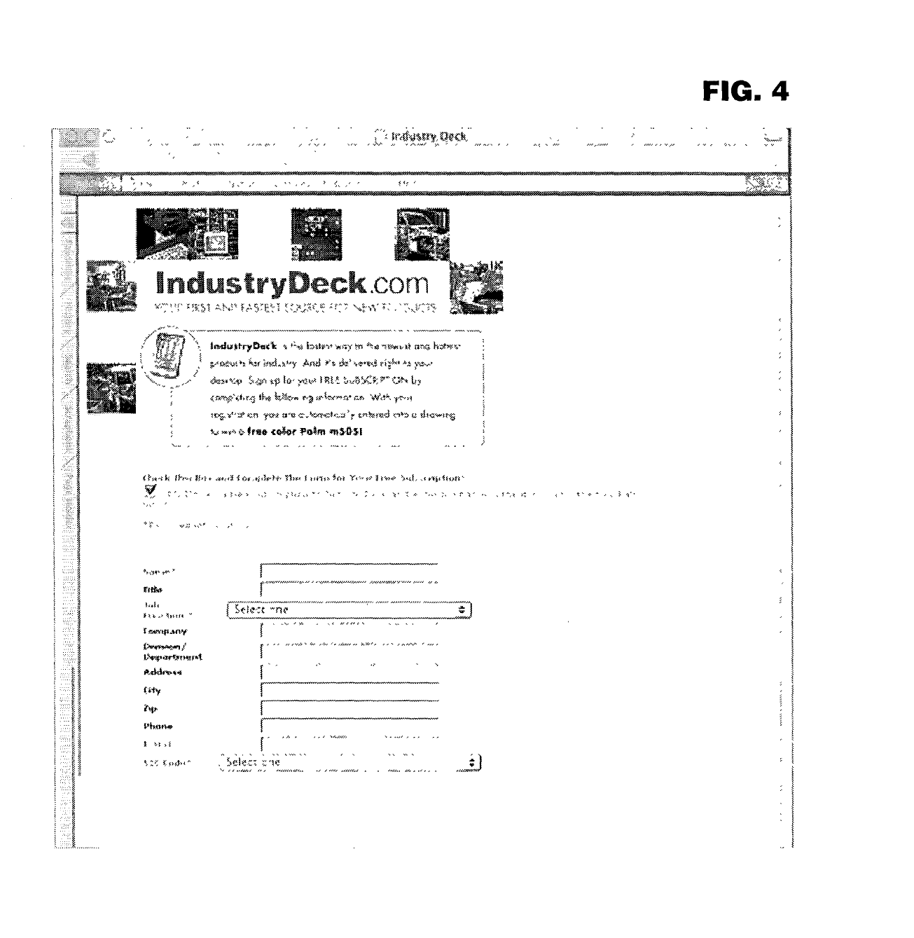

In accordance with the “system” aspect of the invention, the web site incorporates automated registration software to allow individual customers to express consent to receive the Medium (see FIG. 4). The web site also incorporates automated merchant software to facilitate an on-line financial transaction for advertisers to purchase advertising “space” within a given issue, and facilitate transmission of a graphics file from the advertiser and an advertiser-selected referring hyperlink. Individual advertisers (or their contracted vendors) provide advertisements appearing in the Medium. Software automatically routes graphics files and data to a computer that assembles individual deliverable issues of the Medium.

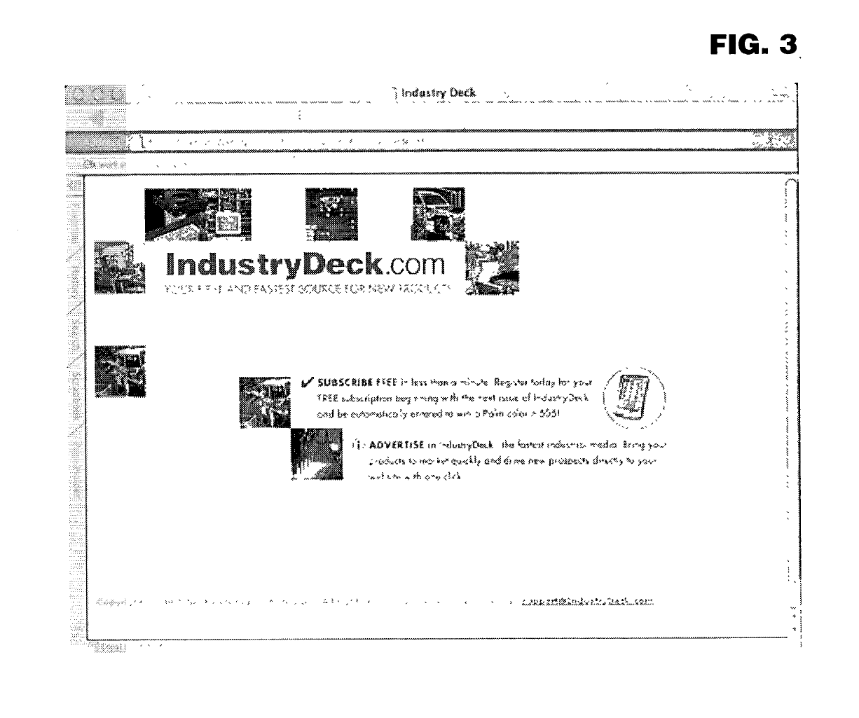

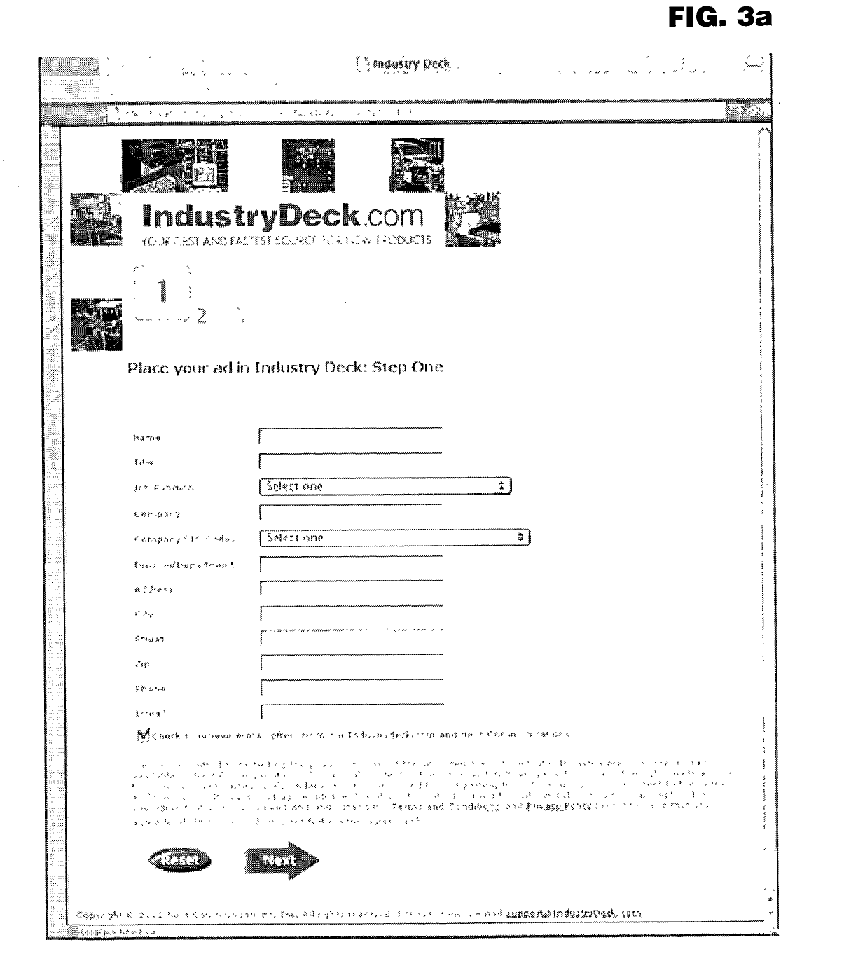

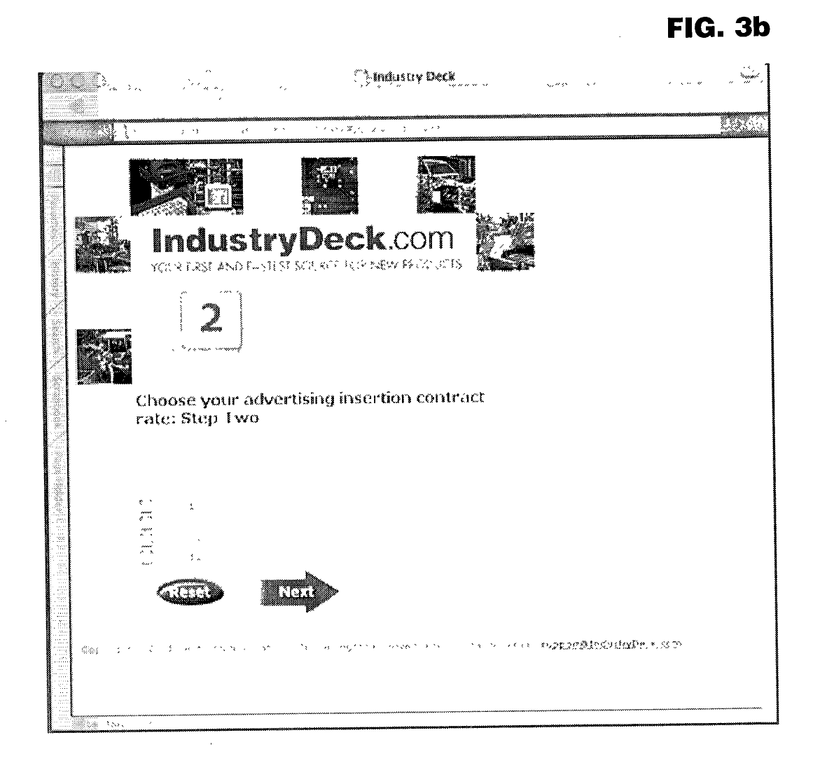

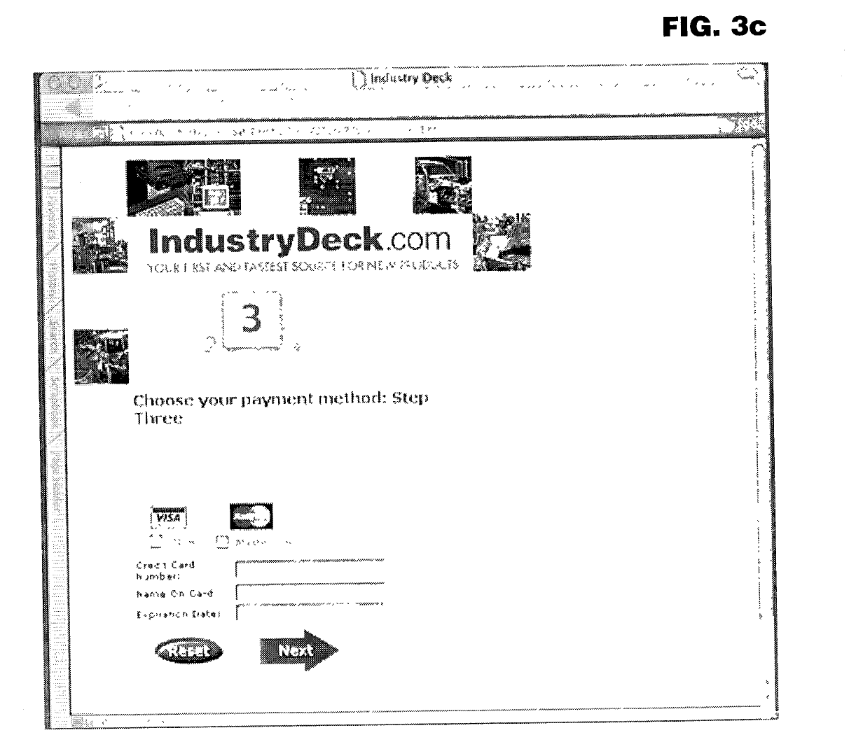

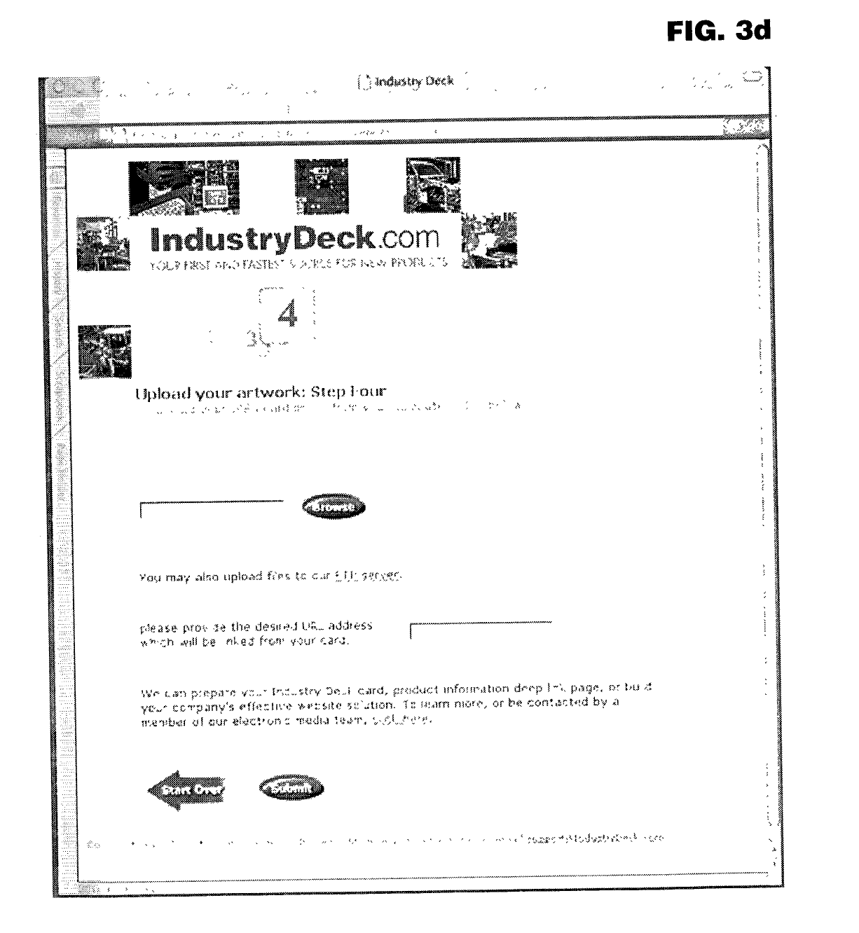

Using a step-by-step method with a CGI-enabled form, advertisers are instructed to read and submit to a contractual Advertising Agreement (reference numerals 12 and 14 in FIG. 1), at which point the advertiser is instructed to transmit (upload) graphics that have been prepared to the specifications of the Medium (reference numeral 16), and supply a user-specified hyperlink (URL) address (reference numeral 16). Graphics files and the specified URL are uploaded to a secure graphics server and the advertiser is then prompted to submit payment via (e-commerce) a secure on-line credit card transaction (reference numeral 18). The e-commerce server routes the payment data and processes the transaction via an outside credit card processing agency (shown generally at 20). Upon approval of the transaction and successful submission of the advertising content, the advertiser receives an automatically generated electronic acknowledgement via e-mail to the advertiser computer (reference numeral 30) and immediate confirmation on the web site (reference numeral 22). The uploaded graphic files (reference numeral 24) are automatically batch processed, compressed (reference numeral 26), and then placed into the specified issue of the Medium (reference numeral 28) via an assembly script along with the desired URL, which automatically prepares the issue of the Medium for distribution with minimal human intervention. Screen shots of the process of FIG. 1 are shown at FIG. 3 through 3d. FIG. 3 shows an intro screen; FIG. 3a shows the registration step; FIG. 3b shows acceptance of the contract rate; FIG. 3c shows the payment step and FIG. 3d shows the upload of the advertising content and the entry of the advertiser's URL.

The Medium 28 is then e-mailed to a plurality of subscribers (reference numeral 32) and when the e-mail is opened the flash document is delivered via the internet to the subscriber's computer. As discussed further below, the subscriber can move through the advertising screens using First, Last, Next and Previous buttons and can access further content from the advertiser via a “Tell Me More” button, which opens an advertiser specified web page in a separate window of the browser when clicked.

The Medium 28 can be configured so that a count of each screen viewed is recorded by the server from which the medium 28 was obtained, as well as recording the count of each “click-through” to advertiser content via a “Tell Me More” button.

In accordance with another aspect of the invention, advertisers will be able to access statistical tracking information via a password-protected section of the web site through use of server-based software. In this manner; advertisers will be able to gauge the effectiveness of their advertisement by accessing ongoing counts of exposures “impressions” and hits (“click-through”) to their unique URL.

2) The Deliverable Medium

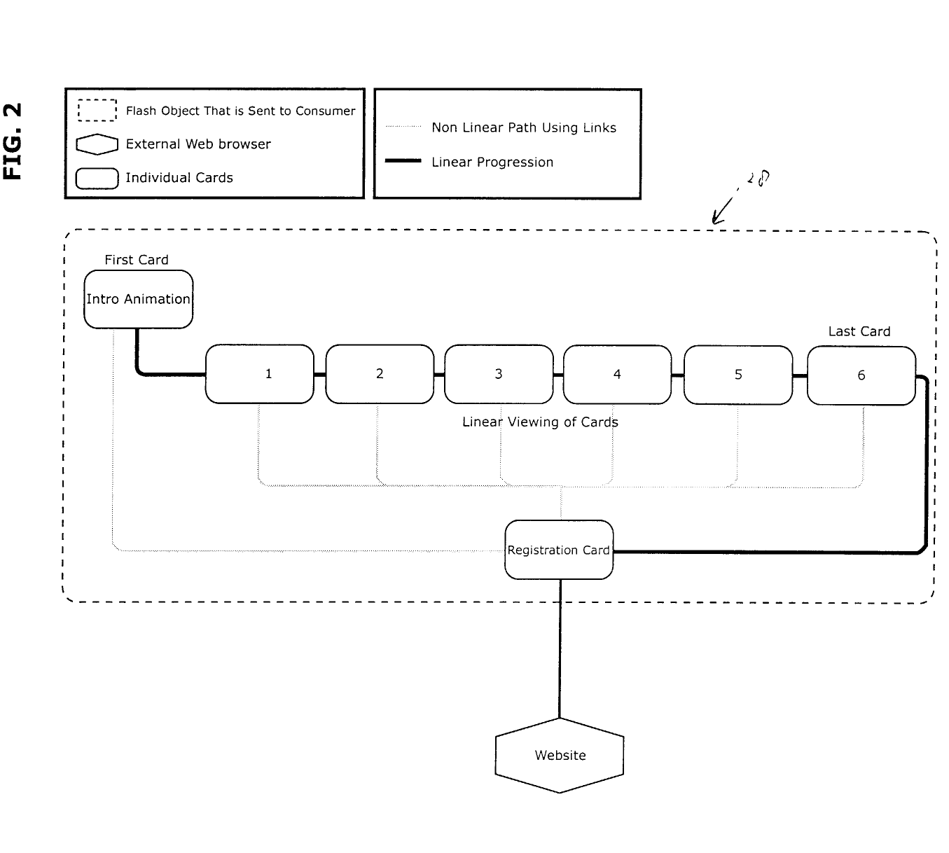

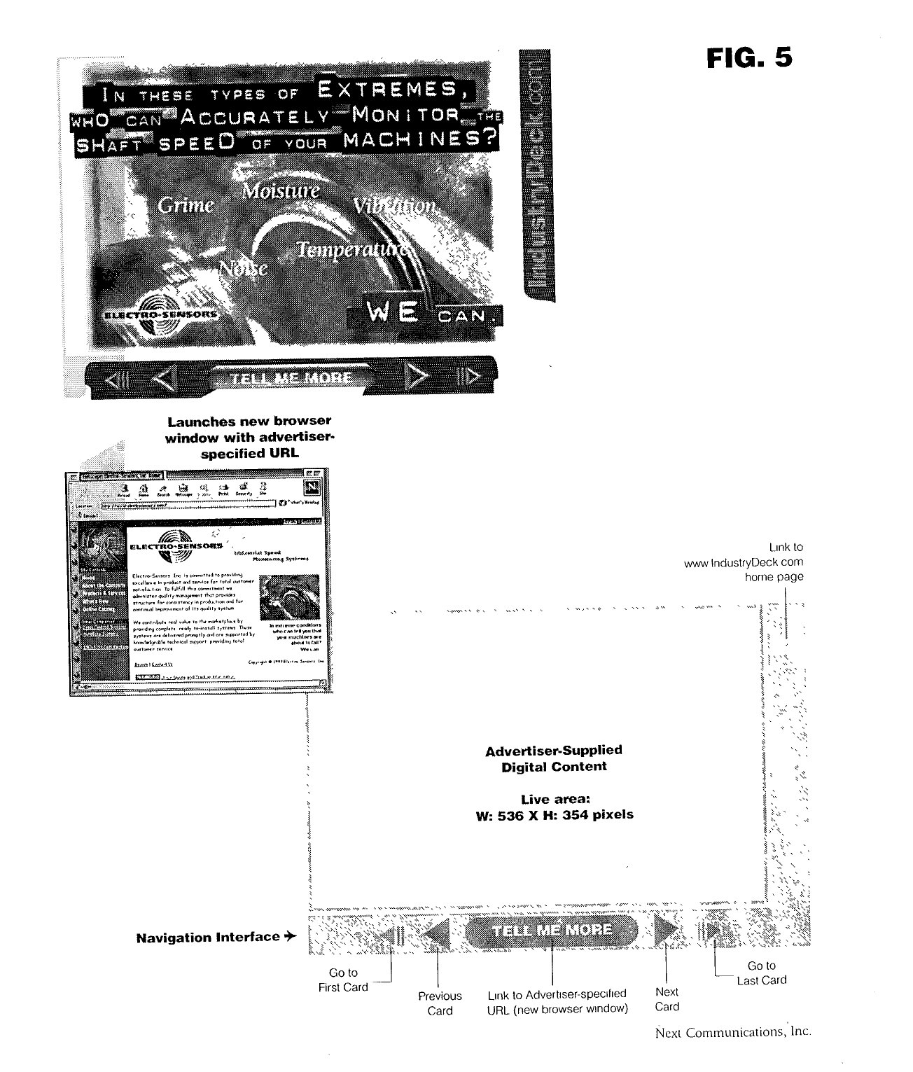

Each issue of the Medium is a HTML (hypertext markup language) document that has been converted into a “Flash object” 28 (see FIG. 2 and FIG. 5)(a standalone web software application utilizing a software authoring tool produced by Macromedia, Inc.) that appears as a graphically-enhanced e-mail transmitted to customers via the Internet.

In accordance with another aspect of the invention, the Flash document 28 that comprises the Medium may also be delivered within an HTML page on the world wide web, allowing users to access the Medium via HTML hyperlink, or the Flash document itself can be embedded directly within an HTML page.

In accordance with another aspect of the invention, a common graphical interface (see FIG. 5 which shows first, last, next, and previous buttons) surrounds the advertisements to facilitate navigation through the individual advertisements and provide access to the referral hyperlink (Tell Me More button) associated with a given advertiser. Because of the intentional linear nature of the interface, which steps forward and backward one card at a time, more impressions are generated than would be by incorporating non-linear navigation methods.

In accordance with another aspect of the invention, the present invention can incorporate Flash/GIF animation, streaming video and audio, interactive features and/or search engines, information gathering devices or surveys, secondary levels of information (additional browser windows), non-linear navigational methods, scrolling capabilities, additional pop-up windows and navigational menus. The present invention can also incorporate editorial content. The present invention can also be delivered with customized content based on user profiles or opted preferences from a menu of presented selections.

There are two customer audiences that will receive e-mailings: a) Registered (enrolled) subscribers; and b) Non-registered, or yet-to-register individuals who have responded to industrial advertising (leads) culled from various sources. A database of these users is continuously maintained offering both registration (opt-in) and removal (opt-out). Non-registered (non-qualified) individuals consist of those e-mail identities culled from client prospect lists, media sources, manually assembled lists, and additional resources. Registered (qualified) Users consist of those who have requested regular e-mailings of the Medium via a registration form on the web site and meet criteria of the Medium's user profile.

In accordance with another aspect of the invention, the Medium interface model is designed to accommodate additional business roles including but not limited to “private branding” of the Medium. An advertiser could upload a subscriber list and have a single company medium e-mailed to the list. The Medium interface model can be applied toward delivery of an Internet based, e-mail based, or CD-ROM based catalog for a single advertising client, or can also incorporate editorial, or “non-advertising” information. The Medium interface model can also be adopted for pre- or in-show e-mailings and/or CD-ROM delivered advertisements to trade show attendees who would be solicited by show participants via a cooperative issue of the Medium distributed by the show organizer, promoter or trade association,

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below (e.g. claim 3 may be taken as alternatively dependent from claim 2; claim 4 may be taken as alternatively dependent on claim 2, or on claim 3; claim 6 may be taken as alternatively dependent from claim 5; etc.).

This completes the description of the preferred and alternate embodiments of the invention. Those skilled in the art may recognize other equivalents to the specific embodiment described herein which equivalents are intended to be encompassed by the claims attached hereto.

What is claimed is:

1. A software advertising application comprising:
a viewer program configured to run on a computer, and
a plurality of software based advertisements,
the viewer program configured to display the plurality of advertisements, one at a time.

2. The software advertising application of claim 1 wherein the computer is configured to have internet access and where the software advertising application is located on a server having internet access, and further wherein the software advertising application is transmitted to the computer in response to opening an e-mail containing an embedded URL.

3. The software advertising application of claim 1 wherein the computer is configured to have internet access and where the software advertising application is located on a server having internet access, and further wherein the software advertising application is transmitted to the computer in response to activation of a web page hyperlink.

4. The software advertising application of claim 1 wherein the computer is configured for internet connection and further wherein each advertisement contains at least one hyperlink, which when activated displays a web page referenced in at least one hyperlink.

5. The software advertising application of claim 4 wherein when the at least one hyperlink is activated, the referenced web page is displayed in a window of a browser program.

6. The software advertising application of claim 4 wherein the at least one hyperlink references a web page containing product information related to the advertisement.

7. The software advertising application of claim 4 wherein at least one hyperlink references a web page for buying the product described in the advertisement.

8. The software advertising application of claim 1 wherein each advertisement is of a predetermined width and height.

9. The software advertising application of claim 1 wherein each advertisement may contain content selected from the group consisting of video, audio and graphics.

10. The software advertising application of claim 9 wherein the content is stored on a server having internet access and which is configured as streaming content in the advertisement.

11. The software advertising application of claim 1 wherein the viewer program has first, next, previous and last buttons to aid in navigating through the plurality of advertisements.

12. The software advertising application of claim 2 wherein the software advertising application is a custom, remotely-hosted software application.

13. The software advertising application of claim 1 wherein the plurality of advertisements relate to products or services of more than one company.

14. The software advertising application of claim 1 wherein the plurality of advertisements relate to products or services of a single company.

15. A system for delivering internet advertising, the system comprising:
a viewer computer configured for internet connection;
a server computer configured for internet connection;
a software advertising application configured for being electronically transmitted through the internet from said server computer to said viewer computer via e-mail, wherein said software advertising application includes a plurality of software based advertisements and the software advertising application is configured to present a window on the viewer computer which display the plurality of software based advertisements one at a time.

16. The system for delivering internet advertising of claim 15 wherein the software advertising application is transmitted to the viewer computer in response to opening an e-mail containing an embedded URL.

17. The system for delivering internet advertising of claim 15 wherein each advertisement contains at least one hyperlink, which when activated displays a web page referenced in at least one hyperlink.

18. The system for delivering internet advertising of claim 17 wherein when the at least one hyperlink is activated, the referenced web page is displayed in a window of a browser program.

19. The system for delivering internet advertising of claim 17 wherein the at least one hyperlink references a web page containing product information related to the advertisement.

20. The system for delivering internet advertising of claim 17 wherein at least one hyperlink references a web page for buying the product described in the advertisement.

21. The system for delivering internet advertising of claim 15 wherein each advertisement is of a predetermined width and height.

22. The system for delivering internet advertising of claim 15 wherein each advertisement may contain content selected from the group consisting of video, audio and graphics.

23. The system for delivering internet advertising of claim 22 wherein the content is stored on a server having internet access and which is configured as streaming content in the advertisement.

24. The software advertising application of claim 15 wherein the viewer program has first, next, previous and last buttons to aid in navigating through the plurality of advertisements.

25. The system for delivering internet advertising of claim 16 wherein the software advertising application is a custom, remotely-hosted software application.

26. The system for delivering internet advertising of claim 15 wherein the plurality of advertisements relate to products or services of more than one company.

27. The system for delivering internet advertising of claim 15 wherein the plurality of advertisements relate to products or services of a single company.

28. The system for delivering internet advertising of claim 15 wherein the software advertising application is configured to transmit to the server information indicating when each page is viewed.

29. The system for delivering internet advertising of claim 19 wherein the software advertising application is configured to transmit to the server information indicating when the product information web page is viewed by clicking the hyperlink.

30. A system for delivering internet advertising, the system comprising:
a viewer computer configured for internet connection;
a server computer configured for internet connection and the display of web page content which includes a software advertising application request hyperlink;
a software advertising application configured to be transmitted through the internet from the server computer to the viewer computer when a URL embedded within an e-mail is activated, wherein said software advertising application includes a plurality of software based advertisements and the computer program is configured to present a window on the viewer computer which display the plurality of software based advertisements one at a time.

31. A method for delivering internet advertising, comprising the steps of:
e-mailing an embedded URL to a viewing computer in an e-mail,
opening the e-mail, which causes a software advertising application to be transmitted to the viewing computer,
the software advertising application including a plurality of software based advertisements and the software advertising application being configured to present a window on the viewing computer which display the plurality of software based advertisements one at a time.

32. A method for delivering internet advertising, comprising the steps of:
providing a server computer configured for internet connection and the display of web page content which includes a software advertising application request hyperlink;
transmitting a computer program through the internet from the server computer to a viewing computer when the software advertising application request hyperlink is activated, wherein said software advertising application includes a plurality of software based advertisements and the software advertising application is configured to present a window on the viewing computer which display the plurality of software based advertisements one at a time.

33. A system for the production of internet advertising, the system comprising:
an advertiser computer configured for internet connection;
a server computer configured for internet connection and the display of web page content including pages to allow the advertiser to register; agree to a contract rate; upload advertising content and pay;
the server computer being further configured to process the uploaded advertising content into a software advertising application configured to be transmitted through the internet from the server computer to the viewer computer when a URL embedded within an e-mail is activated, wherein said software advertising application includes a plurality of software based advertisements and the computer program is configured to present a window on the viewer computer which display the plurality of software based advertisements one at a time.

34. A method for the production of internet advertising, comprising the steps of:
providing a server computer configured for internet connection and the display of web page content;
connecting to the server computer from an advertiser computer connected to the internet;
registering the advertiser via a server web page;
establishing an advertising contract rate via a server web page;
uploading advertising content to the server computer;
paying for the advertising via a server web page;
processing the uploaded advertising content into a software advertising application configured to be transmitted through the internet from the server computer to the viewer computer when a URL embedded within an e-mail is activated, wherein said software advertising application includes a plurality of software based advertisements and the computer program is configured to present a window on the viewer computer which display the plurality of software based advertisements one at a time.
